(19) United States
(12) Patent Application Publication
(10) Pub. No.: US 2026/0259093 A1
(43) Pub. Date: Sep. 3, 2026

(54) DOWNHOLE TOOL WITH FORCE SENSOR

(71) Applicant: KING SOUTHWEST & CONSULTING OF CYPRESS dba KSWC, Houston, TX (US)

(72) Inventors: Santos D. ORTIZ, Houston, TX (US); George R. KING, Houston, TX (US)

(21) Appl. No.: 19/553,550

(22) Filed: Mar. 2, 2026

Related U.S. Application Data
(60) Provisional application No. 63/766,211, filed on Mar. 3, 2025.

(51) Int. Cl. G01L 5/10; E21B 17/02; E21B 47/00; G01L 1/16; G01L 1/22

(52) U.S. Cl. CPC G01L 5/10; E21B 17/023; E21B 47/00; G01L 1/16; G01L 1/22

(57) ABSTRACT

A downhole tool can include a connector welded to a housing, and a sensor element in compression between the connector and the housing. A method of measuring a load applied to a downhole tool can include positioning a sensor element between a connector and a housing, then applying a compressive force to the sensor element, then securing the connector to the housing, thereby maintaining the compressive force in the sensor element, and then deploying the downhole tool into a subterranean well. A wireline cable head can include a weak link that parts at a predetermined tension level applied to the cable head, a connector secured to the weak link and to a housing, and a sensor element in compression between the connector and the housing.

### CROSS-REFERENCE TO RELATED APPLICATION

This application claims the benefit of the filing date of US provisional application no. 63/766211, filed on 3 March 2025. The entire disclosure of this prior application is incorporated herein by this reference for all purposes.

### BACKGROUND

This disclosure relates generally to equipment utilized and operations performed in conjunction with a subterranean well and, in an example described below, more particularly provides a wireline cable head with a tension sensor.

It can be useful to measure tensile and compressive loads applied to downhole tools in a well. For example, in drilling operations, a measurement of weight on bit is used to maintain efficient drilling, steer a drill bit, etc. In wireline operations, it is important to avoid parting of the wireline due to excessive tensile force.

Therefore, it will be readily appreciated that improvements are continually needed in the art of tension and compression measurement in downhole tools. The present disclosure provides such improvements, which may be used in a variety of different downhole tools, and in a variety of different well operations.

### BRIEF DESCRIPTION OF THE DRAWINGS

FIG. 1 is a representative partially cross-sectional view of an example of a well system and associated method which can embody principles of this disclosure.

FIG. 2 is a representative cross-sectional view of an example of a cable head that may be used in the FIG. 1 system and method.

FIG. 3 is a representative cross-sectional view of an example of a tension sensor portion of the cable head.

FIG. 4 is a representative cross-sectional view of another example of the tension sensor portion of the cable head.

### DETAILED DESCRIPTION

Representatively illustrated in the accompanying drawings are examples of a wireline cable head and associated system and method which can embody principles of this disclosure. However, it should be clearly understood that the cable head, system and method are merely one example of an application of the principles of this disclosure in practice, and a wide variety of other examples are possible. Therefore, the scope of this disclosure is not limited at all to the details of the cable head, system and method described herein and/or depicted in the drawings.

A downhole tension sensor disclosed herein can be used with the cable head, or it may be used with other types of well tools. An example of a cable head that can be used with the downhole tension sensor is described in US patent no. 11,608,691 the entire disclosure of which is incorporated herein by this reference in its entirety for all purposes. In other examples, the sensor could be used as an individual tool to measure tension or compression.

In a downhole tension sensor disclosed herein, a piezoelectric material is preloaded in compression to a specified load. A reduction in the compression is used as a tension measurement. In another example, the sensor could comprise a through hole strain gauge.

In one example, outer bodies of the tension sensor are preloaded and then the bodies are welded together to isolate a sensing element from the borehole. The sensor continuously measures compression. When tension is applied to the cable head or other well tool, sensor electronics output the difference from nominal as the exerted tension on the tool.

In the cable head example, the sensor is positioned above threads of a lower adapter in the cable head to be able to isolate the tension measurement in the weak link. In use, this can help an operator avoid unintentional parting of the weak link.

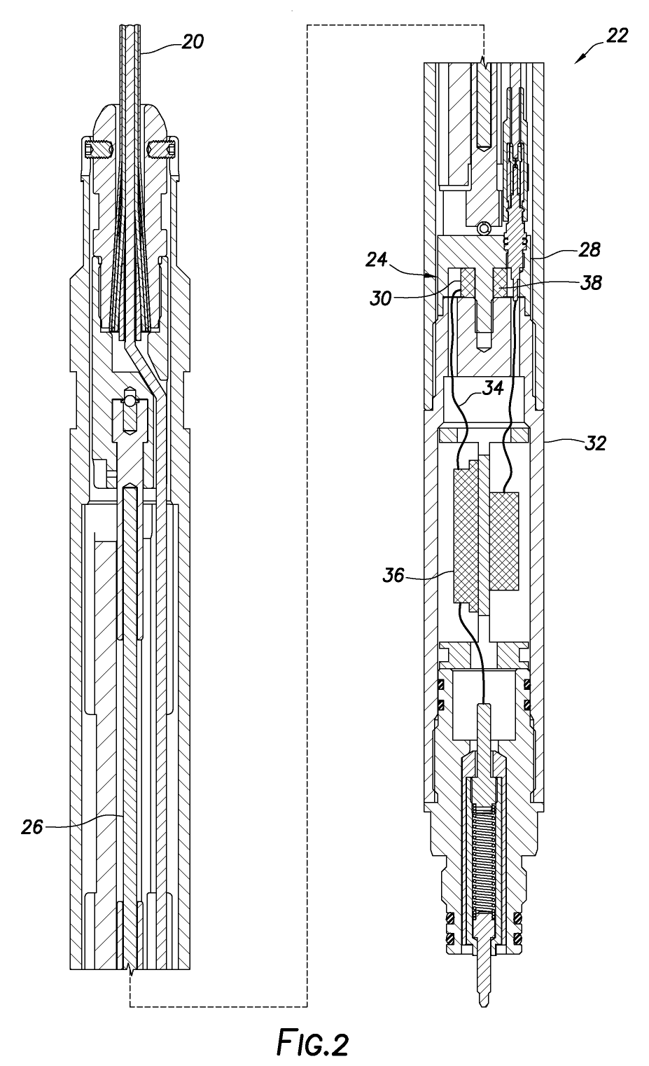

In FIG. 2, a cable head with a downhole tension sensor incorporated therein is representatively illustrated. In this example, the tension sensor can be used to measure tensile force applied to a weak link of the cable head. The cable head is otherwise similar to the cable head described in the US patent no. 11,608,691.

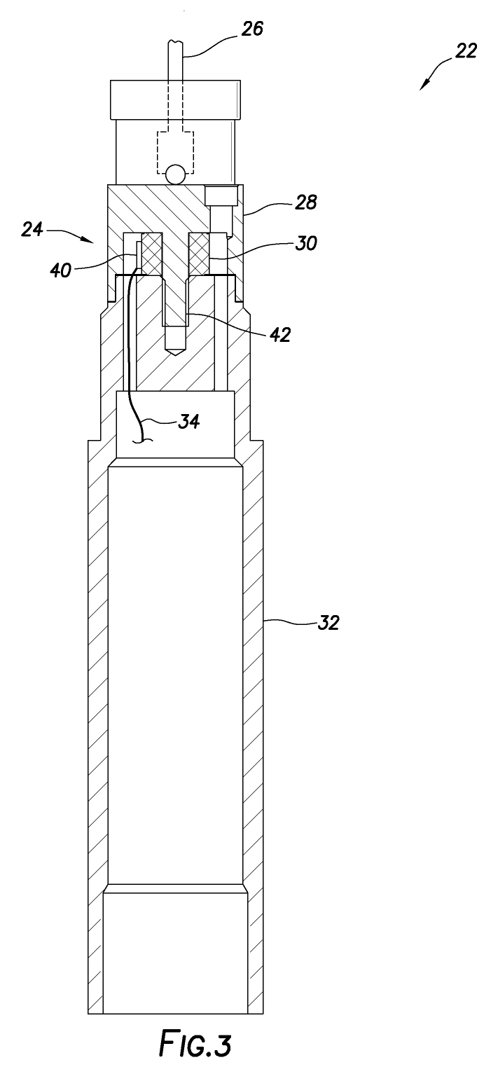

In FIG. 3, a tension sensor portion of the cable head is representatively illustrated apart from the cable head. In this example, the tension sensor includes a housing, a connector, and a piezoelectric sensor element and/or a strain gauge. The sensor chassis and electronics can be received in the housing (as in the FIG. 2 example).

The connector is threaded into the housing. A compressive force applied to the sensor element is directly related to a torque applied to the threaded connection. When a desired compressive force is applied to the sensor element, the connector may be secured to the housing, for example, by welding the connector to the housing.

An upper end of the connector is configured for attachment to a lower end of the weak link (see FIG. 2). Thus, a tensile force applied to the weak link will be observed as a reduction in compression of the sensor element.

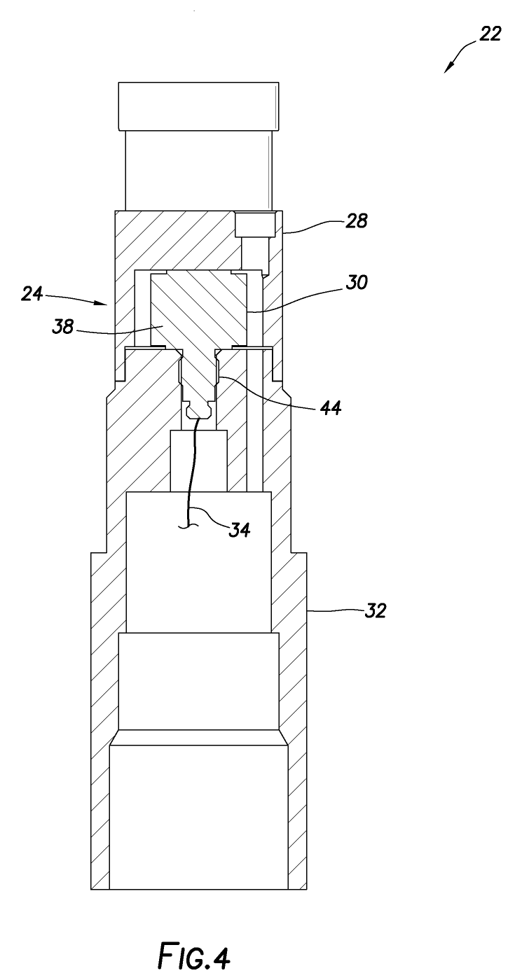

In FIG. 4, another example of the tension sensor is representatively illustrated. In this example, the connector is not threaded into the housing, but the piezoelectric sensor element is attached at an upper end of the housing.

A desired compressive force is applied to the assembly depicted in FIG. 4, and then the connector is secured to the housing, such as, by welding. Otherwise, the FIG. 4 tension sensor functions similar to the FIG. 3 tension sensor.

Note that the tension sensors disclosed herein can also be used as compression sensors. For example, one of the FIGS. 3 & 4 sensors could be used to measure weight on bit in a drilling operation.

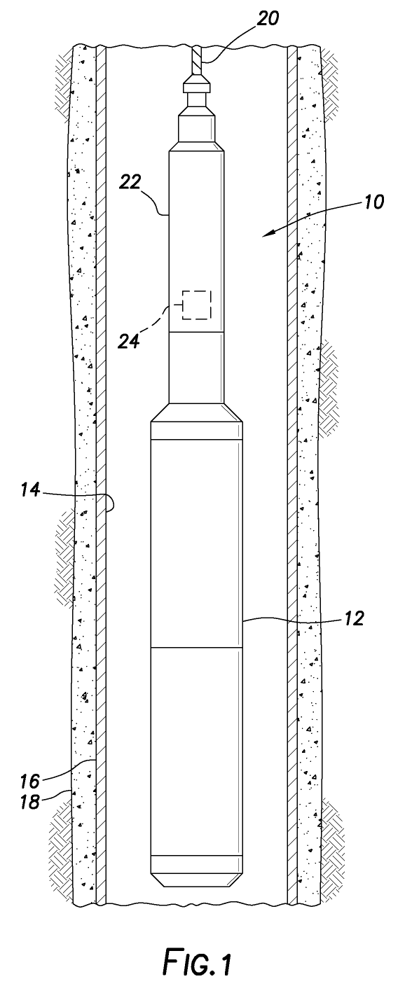

Representatively illustrated in FIG. 1 is a system 10 for use with a subterranean well, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a bottom hole assembly 12 is deployed into a wellbore 14 lined with casing 16 and cement 18. In other examples, the wellbore 14 may be uncased or open hole.

The bottom hole assembly 12 is conveyed in the wellbore 14 by means of a wireline 20 (such as, an e-line or an armored multi-conductor cable). A cable head 22 is used to mechanically and electrically connect the bottom hole assembly 12 to the wireline 20.

In this example, the cable head 22 includes a sensor 24 for measuring a load applied to the cable head. Specifically, the sensor 24 in this example is used to measure tension applied to a weak link (not visible in FIG. 1, see FIG. 2) of the cable head 22. By monitoring the tension applied to the cable head 22, an operator can avoid inadvertent parting of the weak link, or can know when the applied tension reaches a predetermined level at which the weak link should part.

Referring additionally now FIG. 2, a representative cross-sectional view of an example of the cable head 22 is depicted. For convenience, the FIG. 2 cable head 22 is described below as it may be used in the FIG. 1 system 10 and method, but the cable head may be used with other systems and methods in keeping with the scope of this disclosure.

In the FIG. 2 example, the cable head 22 includes a weak link 26. the weak link 26 is secured at its upper end to the wireline 20, and at its lower end to a connector 28. Thus, tension applied to the cable head 22 via the wireline 20 is transmitted to the connector 28 via the weak link 26.

The connector 28 forms part of the tension sensor 24. A sensor element 30 of the sensor 24 is positioned between the connector 28 and a housing 32 of the cable head 22. One or more conductors 34 electrically connect the sensor element 30 to electronic circuitry 36 contained in the housing 32.

In this example, the sensor element 30 comprises a piezoelectric material 38 that produces an electrical potential difference in response to compression of the material. The electrical potential varies with the applied compression, so that by measuring the electrical potential produced by the material 38, the applied compression can be determined. The electronic circuitry 36 can comprise one or more processors, memory, input and output ports, etc., for making this determination (such as, a Wheatstone bridge), or for conditioning the sensor measurements for transmission via the wireline 20 to surface (where the determination can be made).

Referring additionally now to FIG. 3, a representative cross-sectional view of an example of the tension sensor 24 portion of the cable head 22 is depicted. In this example, the sensor element 30 of the sensor 24 comprises a strain gauge 40 (such as, comprising a metallic foil applied to the sensor element). An electrical resistance of the strain gauge 40 can be used to measure strain (and, thus, compression) applied to the sensor element 30.

Note that the FIG. 3 example of the sensor element 30 could include the piezoelectric material 38, as in the FIG. 2 example. The scope of this disclosure is not limited to use of any particular type of sensor element.

To construct the sensor 24, the sensor element 30 is positioned between the connector 28 and the housing 32. The connector 28 and the housing 32 are then threaded together (for example, using threads 42).

Eventually, further threading of the connector 28 into the housing 32 will cause a compressive force to be applied to the sensor element 30. The compressive force increases as the connector 28 is further threaded into the housing 32.

When the compressive force has reached a desired level, the threading together of the connector 28 and the housing 32 is ceased. The connector 28 and the housing 32 are then welded together to maintain the desired level of compressive force applied to the sensor element 30.

When the cable head 22 is fully assembled and connected between the wireline 20 and the bottom hole assembly 12, tension applied to the cable head in the well will result in a reduction in the compressive force applied to the sensor element 30, and this reduction in compression will correspond to the applied tension. When used with the FIG. 2 cable head 22, the reduction in compression will correspond to tension applied to the weak link 26.

Referring additionally now to FIG. 4, a representative cross-sectional view of another example of the tension sensor 24 portion of the cable head 22 is depicted. In this example, the sensor element 30 comprises the piezoelectric material 38. However, in other examples the sensor element could comprise the strain gauge 40 , as in the FIG. 3 example.

As depicted in FIG. 4, the threads 42 are not used to apply an initial compressive force to the sensor element 30. Instead, the sensor element 30 is secured at an upper end of the housing 32 (for example, using threads 44), the connector 28 is positioned over the sensor element, and then the compressive force is applied to this assembly (for example, using a press).

Once the desired compressive force has been applied to the sensor element 30, the connector 28 and the housing 32 are welded together. This maintains the applied compressive force in the sensor element 30. Otherwise, the FIG. 4 example is operationally similar to the FIG. 3 example.

It may now be fully appreciated that the present disclosure provides significant advancements to the art of tension and compression measurement in downhole tools. In one example, a cable head 22 with a tension sensor 24 is provided, with the tension sensor including a sensor element 30 that is in compression when the cable head 22 is deployed into a well.

In the tension sensor 24, the sensor element 30 can be compressed between a housing 32 and a connector 28. The housing 32 and connector 28 may be welded together or otherwise secured together to maintain a compressive force applied to the sensor element 30. The connector 28 may connect to a weak link 26 of the cable head 22.

The sensor element 30 may comprise a piezoelectric material 38. The sensor element 30 may comprise a strain gauge 40.

The present disclosure provides to the art a wireline cable head 22 for use in a subterranean well. In one example, the wireline cable head 22 can include a weak link 26 configured to part at a predetermined tension level applied to the cable head 22, a connector 28 secured to the weak link 26 and to a housing 32 configured for attachment to a bottom hole assembly 12, and a sensor element 30 in compression between the connector 28 and the housing 32.

The housing 32 and the connector 28 may be welded together. The sensor element 30 may be threaded into the housing 32. The connector 28 may be threaded with the housing 32.

The wireline cable head 22 may include electronic circuitry 36 contained in the housing 32 and electrically connected to the sensor element 30.

The above disclosure also provides to the art a method of measuring a load applied to a downhole tool (such as, the cable head 22). In one example, the method can comprise: positioning a sensor element 30 between a connector 28 and a housing 32 of the downhole tool 22; then applying a compressive force to the sensor element 30; then securing the connector 28 to the housing 32, thereby maintaining the compressive force in the sensor element 30; and then deploying the downhole tool 22 into a subterranean well.

The securing step may include welding together the connector 28 and the housing 32.

The method may include securing an end of a weak link 26 to the connector 28.

In the positioning step, the sensor element 30 may comprise a piezoelectric material 38 and/or a strain gauge 40.

The applying step may include threading the connector 28 to the housing 32.

The positioning step may include threading the sensor element 30 to the housing 32.

The method may include positioning electronic circuitry 36 in the housing 32, and electrically connecting the sensor element 30 to the electronic circuitry 36.

Also provided to the art by the present disclosure is a downhole tool (such as, the cable head 22) for use in a subterranean well. In one example, the downhole tool 22 can comprise a connector 28 welded to a housing 32, and a sensor element 30 in compression between the connector 28 and the housing 32.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example’s features are not mutually exclusive to another example’s features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A wireline cable head for use in a subterranean well, the wireline cable head comprising:
a weak link configured to part at a predetermined tension level applied to the cable head;
a connector secured to the weak link and to a housing configured for attachment to a bottom hole assembly; and
a sensor element in compression between the connector and the housing.

2. The wireline cable head of claim 1, in which the housing and the connector are welded together.

3. The wireline cable head of claim 1, in which the sensor element comprises a piezoelectric material.

4. The wireline cable head of claim 1, in which the sensor element comprises a strain gauge.

5. The wireline cable head of claim 1, in which the sensor element is threaded into the housing.

6. The wireline cable head of claim 1, in which the connector is threaded with the housing.

7. The wireline cable head of claim 1, further comprising electronic circuitry contained in the housing and electrically connected to the sensor element.

8. A method of measuring a load applied to a downhole tool, the method comprising:
positioning a sensor element between a connector and a housing of the downhole tool;
then applying a compressive force to the sensor element;
then securing the connector to the housing, thereby maintaining the compressive force in the sensor element; and
then deploying the downhole tool into a subterranean well.

9. The method of claim 8, in which the securing comprises welding together the connector and the housing.

10. The method of claim 8, further comprising securing an end of a weak link to the connector.

11. The method of claim 8, in which, in the positioning step, the sensor element comprises a piezoelectric material.

12. The method of claim 8, in which, in the positioning step, the sensor element comprises a strain gauge.

13. The method of claim 8, in which the applying comprises threading the connector to the housing.

14. The method of claim 8, in which the positioning comprise threading the sensor element to the housing.

15. The method of claim 8, further comprising positioning electronic circuitry in the housing, and electrically connecting the sensor element to the electronic circuitry.

16. A downhole tool for use in a subterranean well, the downhole tool comprising:
a connector welded to a housing; and
a sensor element in compression between the connector and the housing.

17. The downhole tool of claim 16, in which the sensor element comprises a piezoelectric material.

18. The downhole tool of claim 16, in which the sensor element comprises a strain gauge.

19. The downhole tool of claim 16, in which the sensor element is threaded into the housing.

20. The downhole tool of claim 16, in which the connector is threaded with the housing.

21. The downhole tool of claim 16, further comprising electronic circuitry contained in the housing and electrically connected to the sensor element.

22. The downhole tool of claim 16, in which the connector is connected to a weak link configured to part at a predetermined tension level applied to the downhole tool.
